(19) United States
(12) Patent Application Publication
(10) Pub. No.: US 2008/0238864 A1
(43) Pub. Date: Oct. 2, 2008

(54) Light emitting diode driving circuit and liquid crystal display using same

(75) Inventor: Zhan-Wei Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/080,005

(22) Filed: Mar. 31, 2008

(30) Foreign Application Priority Data
Mar. 30, 2007 (CN) 200710073757.3

(51) Int. Cl. G09G 3/36; H05B 37/02

(52) U.S. Cl. 345/102; 315/309

(57) ABSTRACT

A light emitting diode driving circuit includes a light emitting diode, a temperature detector provided adjacent to the light emitting diode, a micro-processor and a constant current circuit. The constant current circuit is configured for generating a driving current to drive the light emitting diode. The micro-processor is configured for generating a plurality of pulse signals with an adjustable duty-cycle, and applying the pulse signals to the constant current circuit. The temperature detector is configured for detecting a present working temperature of the light emitting diode. The micro-processor is configured for adjusting the duty-cycle of the pulse signals according to the detected present working temperature of the light emitting diode. The constant current circuit adjusts the driving current according to the duty-cycle of the pulse signals.

### FIELD OF THE INVENTION

The present invention relates to a light emitting diode driving circuit capable of modulating a driving current of a light emitting diode according to a working temperature, and a liquid crystal display using the light emitting diode driving circuit.

### GENERAL BACKGROUND

Liquid crystal displays are commonly used as displays for compact electronic apparatuses. This is because they not only provide good quality images with little power source consumption, but also they are very thin. The liquid crystal in a liquid crystal display does not emit any light beams itself. Thus, a backlight module is generally needed for a liquid crystal display. The backlight module typically includes one or more light emitting diodes.

Referring to FIG. 7, a typical liquid crystal display 700 includes a liquid crystal panel 710, a light guide plate 720, and a light emitting diode driving circuit 730. Referring also to FIG. 8, the light emitting diode driving circuit 730 includes a light emitting diode 733, a constant current circuit 732, and a micro-processor 731. The constant current circuit 732 includes an input terminal (not labeled) and an output terminal (not labeled). The input terminal of the constant current circuit 732 is connected with the micro-processor 731. The output terminal of the constant current circuit 732 is connected with the light emitting diode 733. The micro-processor 731 applies a plurality of pulse signals to the constant current circuit 732. The constant current circuit 732 receives the pulse signals, and generates a constant current according to duty-cycles of the pulse signals. The constant current drives the light emitting diode 733 to emit light.

Referring to FIG. 9, this shows a relationship between a working temperature limit and a driving current limit for the light emitting diode 733. The working temperature limit and the driving current limit are determined according to the particular production model of the light emitting diode 733. That is, when the light emitting diode 733 works at a certain operating temperature, the driving current should be less than a predetermined threshold value, otherwise the light emitting diode 733 will be damaged. The threshold value is the driving current limit. For example, when the light emitting diode 733 works at an operating temperature of 20° C., a driving current of the light emitting diode 733 should be less than 30 mA (milliamperes).

Similarly, when the light emitting diode 733 works at a certain driving current, the working temperature should be less than a predetermined threshold value, otherwise the light emitting diode 733 will be damaged. The threshold value is the working temperature limit. For example, when the light emitting diode 733 works at a driving current of 25 mA, a working temperature of the light emitting diode 733 should be less than 40° C.

Usually, a driving current of the light emitting diode 733 is constant, and a working temperature of the light emitting diode 733 rises gradually. Once the working temperature exceeds the working temperature limit corresponding to the present driving current, the light emitting diode 733 is liable to be damaged. Even if the light emitting diode 733 is not damaged, the liquid crystal display 700 may work abnormally.

What is needed, therefore, is a light emitting diode driving circuit that can overcome the above-described deficiencies. What is also needed is a liquid crystal display using such a light emitting diode driving circuit.

### SUMMARY

In one preferred embodiment, a light emitting diode driving circuit includes a light emitting diode, a temperature detector provided adjacent to the light emitting diode, a micro-processor and a constant current circuit. The constant current circuit is configured for generating a driving current to drive the light emitting diode. The micro-processor is configured for generating a plurality of pulse signals with an adjustable duty-cycle, and applying the pulse signals to the constant current circuit. The temperature detector is configured for detecting a present working temperature of the light emitting diode. The micro-processor is configured for adjusting the duty-cycle of the pulse signals according to the detected present working temperature of the light emitting diode. The constant current circuit adjusts the driving current according to the duty-cycle of the pulse signals.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various diagrams.

FIG. 1 is a diagram of a light emitting diode driving circuit according to a first embodiment of the present invention, the light emitting diode driving circuit including a light emitting diode.

FIG. 2 is a graph of driving current versus working temperature for the light emitting diode of FIG. 1.

FIG. 3 is a diagram of a light emitting diode driving circuit according to a second embodiment of the present invention.

FIG. 4 is a diagram of a light emitting diode driving circuit according to a third embodiment of the present invention.

FIG. 5 is a diagram of a light emitting diode driving circuit according to a fourth embodiment of the present invention.

FIG. 6 is a block diagram of a liquid crystal display according to an exemplary embodiment of the present invention.

FIG. 7 is a block diagram of a conventional liquid crystal display, the liquid crystal display including a light emitting diode driving circuit.

FIG. 8 is a diagram of the light emitting diode driving circuit of FIG. 7, the light emitting diode driving circuit including a light emitting diode.

FIG. 9 is a graph of a driving current versus working temperature for the light emitting diode of FIG. 8.

### DETAILED DESCRIPTION OF PREFERRED EMBODIMENTS

Reference will now be made to the drawings to describe preferred and exemplary embodiments in detail.

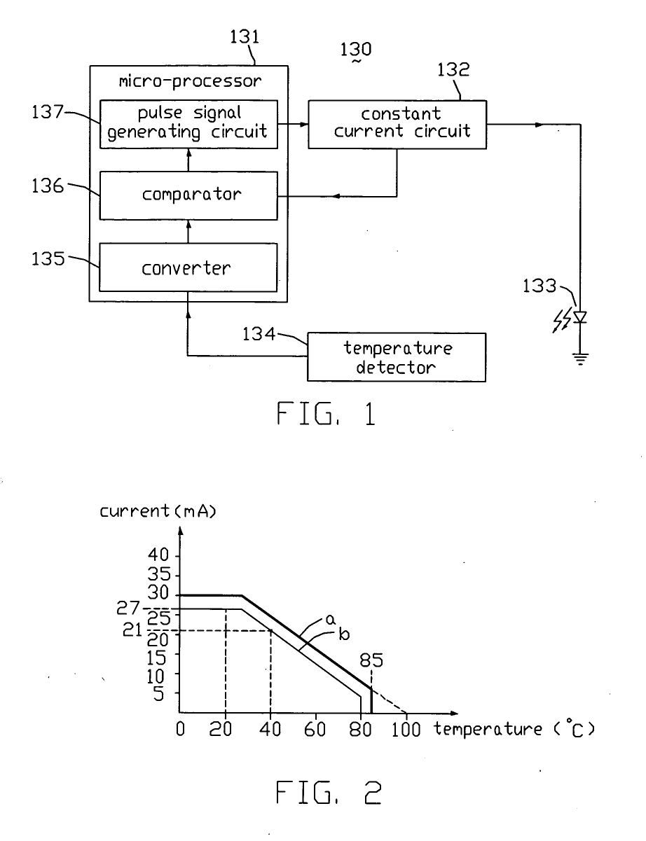

Referring to FIG. 1, a light emitting diode driving circuit 130 according to a first embodiment of the present invention is shown. The light emitting diode driving circuit 130 includes a micro-processor 131, a constant current circuit 132, a light emitting diode 133, and a temperature detector 134. The micro-processor 131 includes a converter 135, a comparator 136, and a pulse signal generating circuit 137. The temperature detector 134 is disposed adjacent to the light emitting diode 133, and includes an output terminal (not labeled). The temperature detector 134 is configured for detecting a present working temperature of the light emitting diode 133, and generating a present working temperature signal accordingly.

The converter 135 includes an input terminal (not labeled) and an output terminal (not labeled). The input terminal is connected with the output terminal of the temperature detector 134 to receive the present working temperature signal. The output terminal is connected with the comparator 136. The converter 135 further includes a program (not shown). The program reads the present working temperature from the present working temperature signal, and outputs a maximum driving current signal accordingly. The maximum driving current signal corresponds to a maximum driving current of the present working temperature. The converter 135 applies the maximum driving current signal to the comparator 136.

The comparator 136 includes a first input terminal (not labeled), a second input terminal (not labeled), and an output terminal (not labeled). The first input terminal of the comparator 136 is connected with the output terminal of the converter 135. The second input terminal of the comparator 136 is connected with the constant current circuit 132. The output terminal of the comparator 136 is connected with the pulse signal generating circuit 137.

The pulse signal generating circuit 137 includes an input terminal (not labeled) connected with the output terminal of the comparator 136, and an output terminal (not labeled) connected with the constant current circuit 132. The pulse signal generating circuit 137 is configured for generating a plurality of pulse signals, and applying the pulse signals to the constant current circuit 132. The pulse signals have constant duty-cycles.

The constant current circuit 132 includes an input terminal (not labeled) connected with the output terminal of the pulse signal generating circuit 137, a first output terminal (not labeled) connected with the second input terminal of the comparator 136, and a second output terminal (not labeled) connected with the light emitting diode 133. The constant current circuit 132 is configured for generating a driving current according to the duty-cycles of the pulse signals. In particular, the driving current is proportional to the duty-cycles of the pulse signals. The driving current drives the light emitting diode 133 to emit light. The constant current circuit 132 further generates a feedback signal according to the present driving current, and provides the feedback signal through the second output terminal thereof to the comparator 136.

The light emitting diode 133 is an AELVVU-D type. Referring also to FIG. 2, a line “a” of a driving current limit of the light emitting diode 133 versus a working temperature limit of the light emitting diode 133 is shown. The working temperature limit and the driving current limit are determined when the light emitting diode 133 is made. In order to provide a margin for error, a line “b” of a maximum driving current of the light emitting diode 133 versus a present working temperature of the light emitting diode 133 is also shown. In practice, a line such as the line “b” is employed. The program in the converter 135 receives the present working temperature signal from the temperature detector 134, and outputs the maximum driving current signal corresponding to the relationship shown as the line “b”. The line “b” can be described by the following formulas:

$$\begin{matrix}I = 27 & ( T \leq 27 ° C . ) , \\ I = - \frac{6}{13} T + \frac{513}{13} & ( 27 ° C . \leq T \leq 80 ° C . ) ;\end{matrix}$$

wherein T denotes the present working temperature of the light emitting diode 133, and I denotes the maximum driving current of the light emitting diode 133.

Operation of the light emitting diode driving circuit 130 is as follows. The pulse signal generating circuit 137 generates a plurality of pulse signals with a constant duty-cycle. The constant current circuit 132 generates a driving current according to the duty-cycle of the pulse signals. The driving current drives the light emitting diode 133 to emit light. The light emitting diode 133 works normally. For example, when the light emitting diode 133 works under a present working temperature of 20° C. and a driving current of 26 mA, the temperature detector 134 detects the present working temperature of the light emitting diode 133, generates a present working temperature signal, and transmits the present working temperature signal to the converter 135. The program in the converter 135 reads the present working temperature, and outputs a maximum driving current signal to the comparator 136. The maximum driving current signal corresponds to a maximum driving current of the present working temperature of 20° C., that is, 27 mA.

The constant current circuit 132 generates a feedback signal according to the present driving current of 26 mA, and provides the feedback signal to the comparator 136. The converter 135 outputs the maximum driving current signal corresponding to the 27 mA driving current to the comparator 136. The comparator 136 compares the two driving signals. Since the present driving current is less than the maximum driving current, the comparator 136 does not act. The light emitting diode driving circuit 130 continues to work normally.

In a further example, the present working temperature of the light emitting diode 133 rises to 40° C., and the present driving current of the light emitting diode 133 remains at 26 mA. The temperature detector 134 detects the present working temperature of 40° C., generates a present working temperature signal accordingly, and provides the present working temperature signal to the converter 135. The program in the converter 135 reads the present working temperature of 40° C., and outputs a maximum driving current signal to the comparator 136. The maximum driving current signal corresponds to a maximum driving current for the present working temperature of 40° C., that is, 21 mA.

The constant current circuit 132 generates a feedback signal according to the present driving current of 26 mA, and provides the feedback signal to the comparator 136. The converter 135 outputs the maximum driving current signal corresponding to 21 mA to the comparator 136. The comparator 136 compares the two driving signals. Since the present driving current is greater than the maximum driving current, the comparator 136 generates a control signal, and applies the control signal to the pulse signal generating circuit 137. The pulse signal generating circuit 137 reduces the duty-cycle of the pulse signals. As a result, the constant current circuit 132 reduces the present driving current to be equal to or less than 21 mA. Therefore, the light emitting diode driving circuit 130 continues to work normally.

Thus, when the present working temperature of the light emitting diode 133 rises from 20° C. to 40° C., the present driving current of the light emitting diode 133 is modulated to be substantially equal to or less than a corresponding maximum driving current. Thereby, the light emitting diode 133 can work normally all the time, even when its working temperature changes.

The converter 135 of the light emitting diode driving circuit 130 can include a look-up table instead of the program. The look-up table stores a plurality of maximum driving current values corresponding to a plurality of working temperatures. The working temperatures and the maximum driving current values follow the relationship shown by the line “b” in FIG. 2. The look-up table receives the present working temperature signal, and outputs a corresponding maximum driving current signal to the comparator 136.

Compared with a conventional light emitting diode driving circuit, the light emitting diode driving circuit 130 includes the temperature detector 134, the comparator 135, the pulse signal generating circuit 137, and the constant current circuit 132. The comparator 136 compares the present driving current and the maximum driving current according to the present working temperature. When the present driving current exceeds the maximum driving current, the comparator 136 generates a control signal, and applies the control signal to the pulse signal generating circuit 137 to reduce the duty-cycle of the pulse signals. As a result, the constant current circuit 132 reduces the driving current of the light emitting diode 133 to be equal to or less than the corresponding maximum driving current. Thus, the light emitting diode 133 can work normally regardless of variations in the working temperature thereof.

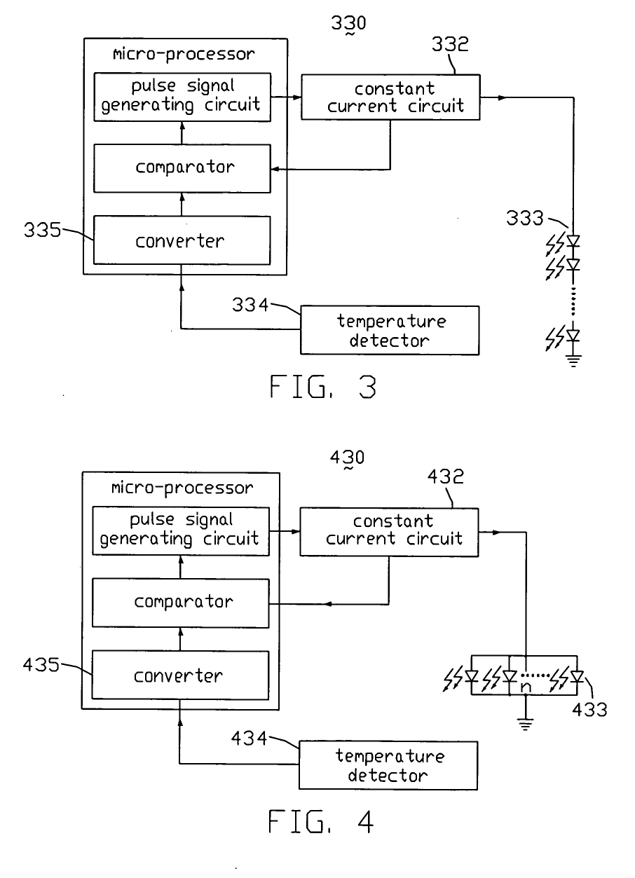

Referring to FIG. 3, a light emitting diode driving circuit 330 according to a second embodiment of the present invention is shown. The light emitting diode driving circuit 330 is similar to the light emitting diode driving circuit 130 of the first embodiment. However, the light emitting diode driving circuit 330 includes a plurality of light emitting diodes 333 of the same type, connected in series. The light emitting diodes 333 are driven by a same constant current circuit 332. A temperature detector 334 is disposed adjacent to all the light emitting diodes 333, to detect working temperatures of all the light emitting diodes 333. The temperature detector 334 chooses the highest working temperature of the light emitting diodes 333, and generates a present working temperature signal corresponding to the highest working temperature. The temperature detector 334 applies the present working temperature signal to a converter 335.

Referring to FIG. 4, a light emitting diode driving circuit 430 according to a third embodiment of the present invention is shown. The light emitting diode driving circuit 430 is similar to the light emitting diode driving circuit 130 of the first embodiment. However, the light emitting diode driving circuit 430 includes a plurality of light emitting diodes 433 of the same type, connected in parallel. The light emitting diodes 433 are driven by a same constant current circuit 432. A driving current of each light emitting diode 433 is with the same as that of each of the other light emitting diodes 433. A summation of the driving currents of all the light emitting diodes 433 is equal to a driving current of the constant current circuit 432. A temperature detector 434 is disposed adjacent to all the light emitting diodes 433, to detect working temperatures of all the light emitting diodes 433. The temperature detector 434 chooses the highest working temperature of the light emitting diodes 433, and generates a present working temperature signal corresponding to the highest working temperature. The temperature detector 434 sends the present working temperature signal to a converter 435.

Referring to FIG. 5, a light emitting diode driving circuit 530 according to a fourth embodiment of the present invention is shown. The light emitting diode driving circuit 530 is similar to the light emitting diode driving circuit 130 of the first embodiment. However, the light emitting diode driving circuit 530 includes a plurality of light emitting diodes 533 connected in parallel in a plurality of branch circuits. Each branch circuit includes a same number of light emitting diodes 533. A driving current of each branch circuit is the same as that of each other branch circuit. A summation of the driving currents of all the branch circuits is equal to a driving current of a constant current circuit 532. A temperature detector 534 is disposed adjacent to all the light emitting diodes 533, to detect working temperatures of all the light emitting diodes 533. The temperature detector 534 chooses the highest working temperature of the light emitting diodes 533, and generates a present working temperature signal corresponding to the highest working temperature. The temperature detector 534 applies the present working temperature signal to a converter 535.

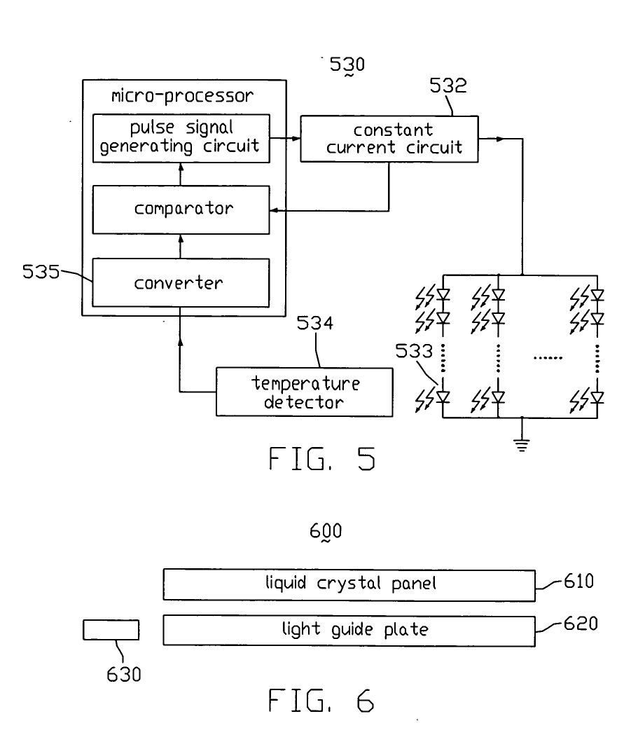

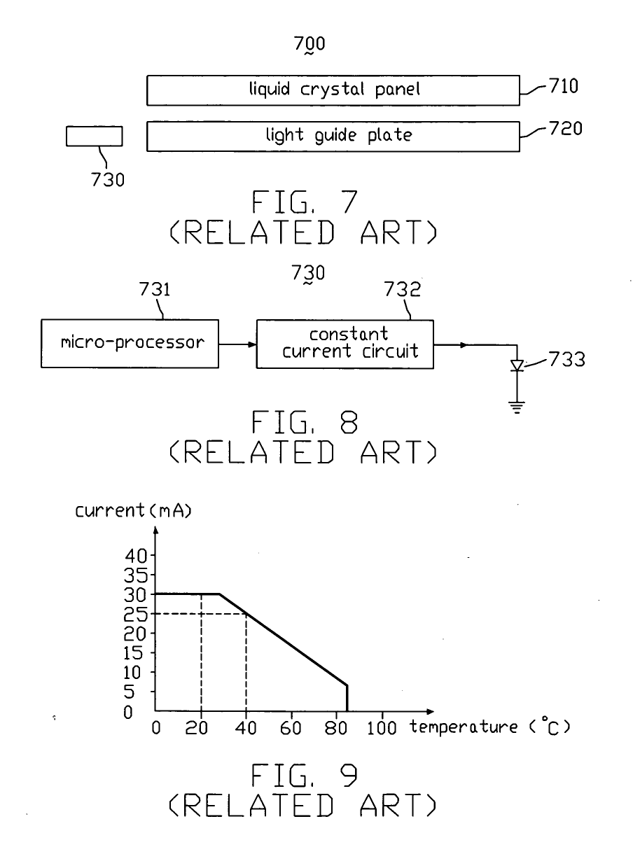

Referring to FIG. 6, a liquid crystal display 600 according to an exemplary embodiment of the present invention is shown. The liquid crystal display 600 includes a liquid crystal panel 610, a light guide plate 620, and a light emitting diode driving circuit 630. The light emitting diode driving circuit 630 can be any one of the light emitting diode driving circuits 130, 330, 430, 530 described above.

Further or alternative embodiments may include the following. In one example, a light emitting diode driving circuit can include one or more light emitting diodes of another type instead of the AELWU-D type. In such case, a relationship between a present working temperature and a present driving current can be different from the relationship shown as the line “b” in FIG. 2. However, operation of such light emitting diode driving circuit is similar to that of the light emitting diode driving circuit 130.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light emitting diode driving circuit comprising:
a light emitting diode;
a constant current circuit configured for generating a driving current to drive the light emitting diode;
a micro-processor configured for generating a plurality of pulse signals with an adjustable duty-cycle, and applying the pulse signals to the constant current circuit; and
a temperature detector provided adjacent to the light emitting diode and configured for detecting a present working temperature of the light emitting diode, the micro-processor adjusting the duty-cycle of the pulse signals according to the detected present working temperature of the light emitting diode, and the constant current circuit adjusting the driving current according to the duty-cycle of the pulse signals.

2. The light emitting diode driving circuit as claimed in claim 1, wherein the driving current is proportional to the duty-cycle of the pulse signals.

3. The light emitting diode driving circuit as claimed in claim 1, wherein the temperature detector generates a present working temperature signal according to the present working temperature of the light emitting diode, and applies the present working temperature signal to the micro-processor.

4. The light emitting diode driving circuit as claimed in claim 1, wherein the micro-processor comprises:
a converter generating a maximum driving current signal corresponding to the present working temperature of the light emitting diode;
a comparator comparing the maximum driving current signal with a present driving current of the light emitting diode, and generating a control signal when the present driving current exceeds a maximum driving current represented by the maximum driving current signal; and
a pulse signal generating circuit generating the pulse signals and receiving the control signal, the control signal determining an adjusted duty-cycle of the pulse signals.

5. The light emitting diode driving circuit as claimed in claim 4, wherein the converter comprises a program, the program generating the maximum driving current signal, the maximum driving current signal representing a maximum driving current predetermined as corresponding to the present working temperature.

6. The light emitting diode driving circuit as claimed in claim 5, wherein a predetermined relationship between the present working temperature of the light emitting diode and the maximum driving current of the light emitting diode is as follows:
$$\begin{matrix}I = 27 & ( T \leq 27 ° C . ) , \\ I = - \frac{6}{13} T + \frac{513}{13} & ( 27 ° C . \leq T \leq 80 ° C . ) ,\end{matrix}$$
T denoting the present working temperature of the light emitting diode, and I denoting the maximum driving current corresponding to the present working temperature.

7. The light emitting diode driving circuit as claimed in claim 4, wherein the constant current circuit generates a feedback signal according to the present driving current of the light emitting diode, and applies the feedback signal to the comparator.

8. The light emitting diode driving circuit as claimed in claim 1, further comprising at least another light emitting diode, wherein all the light emitting diodes are connected with each other in series.

9. The light emitting diode driving circuit as claimed in claim 8, wherein the temperature detector is adjacent to all the light emitting diodes, the temperature detector detecting a highest working temperature of the light emitting diodes, generating a present working temperature signal according to the highest working temperature, and transmitting the present working temperature signal to the micro-processor.

10. The light emitting diode driving circuit as claimed in claim 1, further comprising at least another light emitting diode, wherein all the light emitting diodes are connected with each other in parallel.

11. The light emitting diode driving circuit as claimed in claim 10, wherein the temperature detector is adjacent to all the light emitting diodes, the temperature detector detecting a highest working temperature of the light emitting diodes, generating a present working temperature signal according to the highest working temperature, and transmitting the present working temperature signal to the micro-processor.

12. The light emitting diode driving circuit as claimed in claim 1, further comprising a plurality of light emitting diodes, all the light emitting diodes forming a plurality of branch circuits, each branch circuit comprising a same number of the light emitting diodes.

13. The light emitting diode driving circuit as claimed in claim 12, wherein the temperature detector is adjacent to all the light emitting diodes, the temperature detector detecting a highest working temperature of the light emitting diodes, generating a present working temperature signal according to the highest working temperature, and transmitting the present working temperature signal to the micro-processor.

14. A liquid crystal display comprising:
a liquid crystal panel,
a light guide plate, and
a light emitting diode driving circuit, the light emitting diode driving circuit comprising:
a light emitting diode;
a constant current circuit configured for generating a driving current to drive the light emitting diode;
a micro-processor configured for generating a plurality of pulse signals with an adjustable duty-cycle, and applying the pulse signals to the constant current circuit; and
a temperature detector provided adjacent to the light emitting diode and configured for detecting a present working temperature of the light emitting diode, the micro-processor adjusting the duty-cycle of the pulse signals according to the detected present working temperature of the light emitting diode, and the constant current circuit adjusting the driving current according to the duty-cycle of the pulse signals.

15. The liquid crystal display as claimed in claim 14, wherein the driving current is proportional to the duty-cycle of the pulse signals.

16. The liquid crystal display as claimed in claim 14, wherein the temperature detector generates a present working temperature signal according to the present working temperature of the light emitting diode, and applies the present working temperature signal to the micro-processor.

17. The liquid crystal display as claimed in claim 14, wherein the micro-processor comprises:
a converter generating a maximum driving current signal corresponding to the present working temperature of the light emitting diode;
a comparator comparing the maximum driving current signal with a present driving current of the light emitting diode, and generating a control signal when the present driving current exceeds a maximum driving current represented by the maximum driving current signal; and
a pulse signal generating circuit generating the pulse signals and receiving the control signal, the control signal determining an adjusted duty-cycle of the pulse signals.

18. The liquid crystal display as claimed in claim 17, wherein the converter comprises a program, the program generating the maximum driving current signal, the maximum driving current signal representing a maximum driving current predetermined as corresponding to the present working temperature.

19. The liquid crystal display as claimed in claim 18, wherein a predetermined relationship between the present working temperature of the light emitting diode and the maximum driving current of the light emitting diode is as follows:
$$\begin{matrix}I = 27 & ( T \leq 27 ° C . ) , \\ I = - \frac{6}{13} T + \frac{513}{13} & ( 27 ° C . \leq T \leq 80 ° C . ) ,\end{matrix}$$
T denoting the present working temperature of the light emitting diode, and I denoting the maximum driving current corresponding to the present working temperature.

20. The liquid crystal display as claimed in claim 17, wherein the constant current circuit generates a feedback signal according to the present driving current of the light emitting diode, and applies the feedback signal to the comparator.
